(19) United States
(12) Patent Application Publication
(10) Pub. No.: US 2025/0060648 A1
(43) Pub. Date: Feb. 20, 2025

(54) ELECTRO-ACTIVE LENSES WITH MULTIPLE ELECTRODE LAYERS

(71) Applicant: e-Vision Smart Optics, Inc., Sarasota, FL (US)

(72) Inventor: Anthony Van Heugten, Sarasota, FL (US)

(73) Assignee: e-Vision Smart Optics, Inc., Sarasota, FL (US)

(21) Appl. No.: 18/938,853

(22) Filed: Nov. 6, 2024

Related U.S. Application Data
(63) Continuation of application No. PCT/US2023/066810, filed on May 10, 2023.
(60) Provisional application No. 63/340,134, filed on May 10, 2022.

(51) Int. Cl. G02F 1/29

(52) U.S. Cl. CPC G02F 1/294

(57) ABSTRACT

Concentric ring electrodes in a conventional electro-active lens are arranged in the same layer and spaced apart from each other to prevent electrical shorts. The spacing between electrodes depends on the substrate material and how the electrodes are made. Ideally, the electrodes should be as close together as possible to prevent eddies or discontinuities in the electric field that the electrodes apply to the electro-active material in the electro-active lens. These eddies or discontinuities degrade the electro-active lens's optical quality. Unfortunately, current photolithographic patterning processes cannot produce gaps smaller than about 5 microns on plastic substrates. To compensate for this constraint, the electrodes can be arranged on the substrate in two or more staggered layers, with the electrodes in one layer appearing to fill the gaps in the other layer(s) when looking through the electro-active lens. This eliminates apparent gaps between electrodes even with plastic substrates and coarse patterning resolution.

### CROSS-REFERENCE TO RELATED APPLICATION(S)

This application is a bypass continuation of International Application No. PCT/US2023/066810, filed on May 10, 2023, which claims the priority benefit, under 35 U.S.C. 119 (c), of U.S. Application No. 63/340,134, filed on May 10, 2022, which is incorporated herein by reference in its entirety for all purposes.

### BACKGROUND

Electro-active lenses can be made by several methods, including patterning a series of concentric electrodes of conductive material on a first substrate, then sandwiching a layer of liquid crystal between the first substrate and second substrate opposite the first substrate. The second substrate may have one or more circular patterns of conductive material patterned on it, or any other shape to match or exceed the area of the patterned electrodes, allowing an electrical circuit to be formed that creates a voltage field between the two substrates. When an electrical field is applied across the electrodes, the liquid crystal material between the two substrates changes its index of refraction.

By applying a gradient of voltage fields at different electrode locations on the lens, a gradient of index of refraction may be created, creating a lens. The higher the number of electrodes that are used, the finer the resolution of gradient of refractive index can be created. This results in a smoother wavefront curvature, and hence provides a better-quality optic.

However, increasing the number the electrodes also increases the complexity of the electronics as well as the light-blocking elements that supply power to the electrodes, so methods have been developed to allow a small number of power supply lines to apply a voltage gradient across a larger number of electrodes. In particular, N power supply lines can be used to apply a voltage gradient across M>N electrodes with resistive bridges between the electrodes. In these electro-active lenses, every M/Nth electrode is connected to a power supply line, and the other electrodes are coupled to each other with resistive bridges.

U.S. Pat. No. 9,280,020 to Bos et al., which is incorporated herein by reference, discloses an electro-active lens with resistive bridges that are made in the same plane as the electrodes. These resistive bridges are in gaps in the electrode rings. Unfortunately, these gaps degrade the optical quality of the electro-active lens. Reducing the gap size improves optical performance but can make manufacturing the resistive bridges more complicated. In addition, the electro-active lens in U.S. Pat. No. 9,280,020 consume too much power to be practical because the resistive bridges provide short pathways for the electrical current to flow from one drive channel to the others. This extra current flow leads to an undesired increase in the power consumption of the electro-active lens.

U.S. Pat. No. 10,599,006 to Van Heugten et al., which is also incorporated herein by reference, addresses these problems by providing electro-active lenses with larger, higher resistance bridges that do not degrade the lens's optical performance. In these designs, the electrodes are in one layer and the resistive bridges are in another layer, with a layer of insulating material between the electrode layer and the resistive bridge layer, so the electrodes can remain continuous and close together. In addition, there is no need to remove or sacrifice surface area from the electrodes to make room for these “raised” resistive bridges. As a result, the raised resistive bridges can be larger and have higher resistances, allowing the electro-active lens to operate at much lower power consumption.

### SUMMARY

When made on glass substrates, electro-active lenses like those disclosed in U.S. Pat. No. 10,599,006 can have concentric ring electrodes separated by gaps of 1.5-2 microns to prevent the electrodes from electrically shorting out. These electrodes provide excellent electrical and optical performance, but electro-active lenses with glass substrates are not as suitable for mass production as electro-active lenses with plastic substrates, polymer substrates, or other non-glass substrates. Unfortunately, current lithography process for patterning electrodes on plastic substrates cannot produce concentric ring electrodes with gaps smaller than about 5.5 microns. Gaps this big degrade the electro-active lens's optical performance.

The present technology addresses the problem of wide gaps between adjacent electrodes in an electro-active lens made on a plastic substrate. In fact, it can be used to eliminate the gaps between adjacent electrodes on any type of substrate. Instead of forming the electrodes in a single layer, the electrodes are made in two or more layers separated by respective layers of insulating material, where the gaps between the electrodes in each layer can be as large as needed. Like a shadow-box or board-on-board fence, the electrodes in each layer are arranged in a staggered fashion on different sides of the insulating layers, with the electrodes on one side spanning the gaps between the electrodes on the other side of the insulating layer. When viewed along the electro-active lens's optical axis, however, there may be no gaps visible between electrodes. The electrodes are connected to resistive bridges and/or buss lines on a separate layer to provide good electrical performance. Although gaps of 1.5 to 2.0 um in the current art is good, being able to reduce the gaps to zero using this method further improves the optical quality. This new approach enables zero gaps along the optical axis while preserving electrical isolation.

To see how, consider an electro-active lens with two layers of concentric ring electrodes centered on the electro-active lens's optical axis and numbered consecutively from the innermost ring to the outermost ring. The first electrode layer includes the odd-numbered electrodes and the second electrode layer includes the even-numbered electrodes. A thin layer of insulating material separates the first and second electrode layers. In each layer, each electrode is separated from the adjacent electrode(s) by a gap that is x microns wide and filled with insulating material (i.e., there is a gap of x microns between the first and third electrodes in the first layer and a gap of x microns between the second and fourth electrodes in the first layer). This gap can be 5.5 microns or larger, depending on the resolution of the photolithography process used to make the electrodes. If the electrodes are as wide as the gap or wider, however, there appears to be no gap between consecutively numbered electrodes when looking through the electro-active lens along its optical axis. Eliminating the gap between electrodes along the perspective of the optical axis improves the electro-active lens's optical performance.

In a preferred embodiment of electrode sizing and spacing, the width of the electrodes become progressively narrower the further that they are located away from the center of the optical axis of the electro-active lenses. In one example, the second electrode from the center is 151 microns wide, the third electrode is 118 microns wide, and the fourth electrode is 99 microns wide. If the second and fourth electrodes are on the upper level, and the third electrode is on the lower level, the gap between the second and fourth electrodes is 118 microns, the width of the third electrode is the same as the gap between the second and fourth electrodes (i.e., 118 microns in this example). The inner edge of the third electrode is aligned to the outer edge of the second electrode, and the outer edge of the third electrode is aligned to the inner edge of the fourth electrode.

As readily understood by those skilled in the art of designing optics, the electrode dimensions, spacings, and alignments can be calculated using MATLAB or another suitable programming language. The following MATLAB code can be used to calculate the radii and locations of the lens electrodes for a given design wavelength and optical path distance (OPD) per electrode:

```
% Example 30 mm lens electrode location calculator:
f = 1; %focal length (m)
stepsize = 1E−6; %sample rate of the OPD profile in m
designwavelength = 550e−9; % optimum wavelength of the lens
maxradius = 15E−3; %size of the lens
OPDstep = 1/8; %OPD step per electrode
radius = 0:stepsize:maxradius;
radiusindex = length(radius);
OPD = radius.\hat{ }2 / (2 * f * designwavelength); % Calculate the ideal
OPD profile
j = 1;
for i = 1:radiusindex
if OPD(i) > j*OPDstep
  Electrodelocation(j) = radius(i); % This is the interface
between electrodes (i.e., gap location)
  j = j + 1;
end
end
```

The inventive electro-active lenses disclosed herein are suitable for use as intraocular lenses, contact lenses, spectacle lenses, or lenses for an augmented or virtual reality systems. Such an electro-active lens can include a first substantially transparent substrate, first electrodes on the first substantially transparent substrate, a first insulating layer on the first electrodes, second electrodes on the first insulating layer, and a second insulating layer on the second electrodes. The lens also includes a resistive bridge that is on the second insulating layer and connects one of the first electrodes with one of the second electrodes via holes patterned into the first (and optionally the second) insulating layer(s).

The first electrodes can be staggered radially with respect to the second electrodes. The first electrodes comprise a first ring electrode and the second electrodes comprise a second ring electrode concentric with the first ring electrode. When viewed along an optical axis of the electro-active lens, no gap is apparent between the first ring electrode and the second ring electrode concentric. The first ring electrode can have an outer radius that is at least equal to an inner radius of the second ring electrode.

There may be gaps between adjacent pairs of the first electrodes and gaps between adjacent pairs of the second electrodes. At least one of the gaps between the adjacent pairs of the first electrodes may be at least 5.5 microns wide. There can be insulating material in the gaps between the adjacent pairs of the first electrodes and in the gaps between the adjacent pairs of the second electrodes.

The electro-optic lens may also include a second substantially transparent substrate liquid crystal material sandwiched between the first and second substantially transparent substrates. The liquid crystal material changes a focus of the electro-active lens in response to actuation by the first and/or second electrodes.

Another inventive electro-active lens may include a first plastic substrate, a second plastic substrate, liquid crystal material disposed between the first and second plastic substrates, first electrodes disposed on the first plastic substrate and separated from each other by first gaps of 5 microns, an insulating layer disposed on the first electrodes, and second electrodes disposed on the insulating layer, separated from each other by second gaps of 5 microns, and staggered with respect to the first electrodes. In operation, the first and second electrodes apply an electric field to the liquid crystal material, thereby changing a focus of the electro-active lens.

The first and second electrodes can be first and second concentric ring electrodes, respectively. When viewed along an optical axis of the electro-active lens, the first concentric ring electrodes can appear to occupy the second gaps and the second concentric ring electrodes can appear to occupy the first gaps. One of the first concentric ring electrodes can have a first inner radius and a first outer radius and one of the second concentric ring electrodes can have a second inner radius greater than (e.g., ≤2.0 μm greater than) the first inner radius and less than (e.g., ≤2.0 μm less than) the first outer radius.

The insulating layer can be a first insulating layer comprising first insulating material disposed on the first concentric ring electrodes and in the first gaps. This first insulating material electrically isolates the first concentric ring electrodes from each other and from the second concentric ring electrodes. There can be second insulating material disposed on the second concentric ring electrodes and in the second gaps and electrically isolating the second concentric ring electrodes from each other.

The electro-active lens can also include one or more (raised) resistive bridges disposed on the second insulating material. Each of these resistive bridges is in electrical connection with corresponding subsets of the first and second concentric ring electrodes.

Alternatively, the electro-active lens can include resistive arcs. For example, there may be a first resistive arc formed on the first plastic substrate and connecting one of the first concentric ring electrodes with one of the second concentric ring electrodes through a first via in the first insulating layer. Similarly, there may be a second resistive arc formed on the first insulating layer and connecting another one of the second concentric ring electrodes with another one of the first concentric ring electrodes through a second via in the first insulating layer.

An inventive electro-active lens can be made by forming first electrodes on a substantially transparent substrate with first gaps therebetween. A first insulating layer can be disposed on the first electrodes and in the first gaps. Second electrodes are formed staggered radially with respect to the first electrodes on the first insulating layer with second gaps therebetween. A second insulating layer is disposed on the second electrodes and in the second gaps. Buss lines are formed connecting to at least some of the first electrodes through the first insulating layer and the second insulating layer and/or to at least some of the second electrodes through the second insulating layer. The substantially transparent substrate can be a plastic substrate and forming the first electrodes can include photolithographically patterning the first electrodes with a feature size of at least 5 microns. If desired, a resistive bridge can be electrically connected to a subset of the first electrodes and a subset of the second electrodes. Alternatively, respective resistive arcs can be formed in the planes of the first and second electrodes and connected to respective first or second electrodes through vias or holes in the first insulating layers.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a view along the optical axis of a single layer of concentric ring electrodes for a conventional electro-active lens with a glass substrate.

FIG. 2 shows a view along the optical axis of a single layer of concentric ring electrodes for a conventional electro-active lens with a plastic substrate.

FIG. 3A is a view along the optical axis of a first layer of concentric ring electrodes for use in an electro-active lens with a pair of staggered layers of concentric ring electrodes.

FIG. 3B is a view along the optical axis of a second layer of concentric ring electrodes for use in an electro-active lens with a pair of staggered layers of concentric ring electrodes.

FIG. 4 is a view along the optical axis of an electro-active lens with a pair of the first and second staggered layers of concentric ring electrodes.

FIG. 5 is a perspective view of an electro-active lens with a pair of staggered layers of concentric ring electrodes.

FIG. 6 is a cross-sectional view of an electro-active lens with a pair of staggered layers of concentric ring electrodes separated by insulating material.

FIG. 7 shows a cross section of an electro-active lens with a single layer of raised resistive bridges and a single layer of electrodes.

FIG. 8 is a cross-sectional view of an electro-active lens with a pair of staggered layers of concentric ring electrodes separated by insulating material and connected by a resistive bridge.

FIG. 9 shows a plan view of the electro-active lens of FIG. 8.

FIGS. 10A-10D different layers of electrodes connected by resistive arcs for an electro-active lens with staggered electrodes.

FIG. 11A show an electro-active lens with the electrodes and resistive arcs in FIGS. 10A-10D.

FIG. 11B shows vias and buss electrodes for the electro-active lens of FIG. 11A.

### DETAILED DESCRIPTION

Electro-Active Lenses with Single Layers of Electrodes

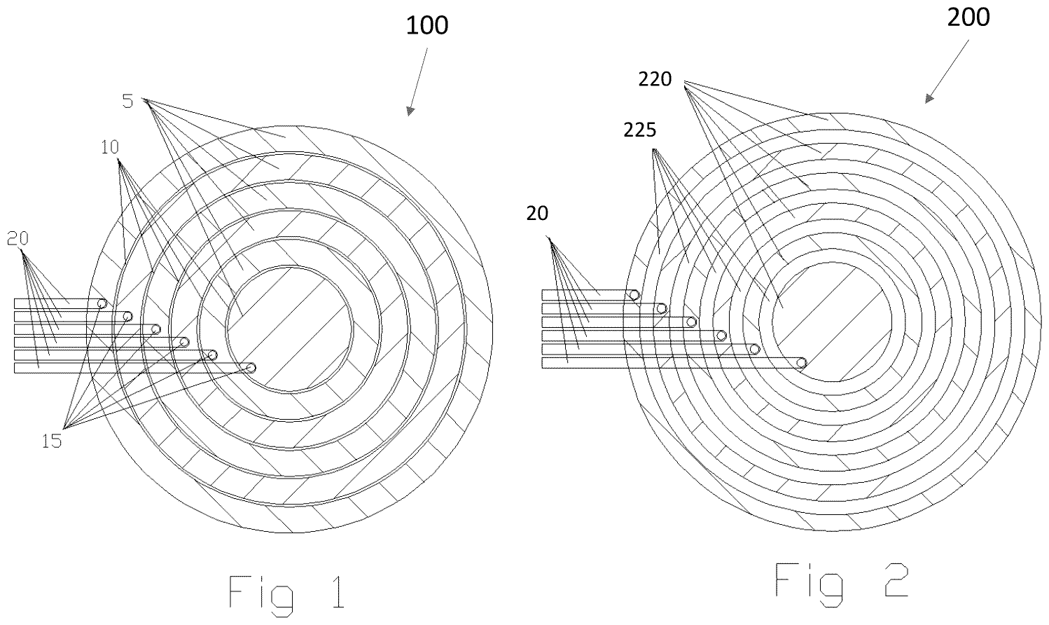

FIG. 1 shows a plan view of an electro-active lens 100 with a single layer of concentric annular or ring-shaped electrodes 5 on a glass substrate. The electrodes 5 conduct electricity and are almost completely transparent. They can be made of indium tin oxide (ITO), silver nanowires, carbon nanotubes, or any other suitable material(s). The electrodes 5 are patterned lithographically and are separated by thin gaps 10, which are readily apparent when looking through the electro-active lens 100 along its optical axis (into and out of the plane of FIG. 1). A layer of transparent insulating material (not shown) covers the electrodes 5 and fills the gaps 10. The insulation layer should be electrically insulating (non-conductive), thin (e.g., 0.25 μm to 0.5 μm thick), and transparent. Suitable materials for the insulation layer include silicon dioxide (SiO₂) and transparent photoresist, such as SU-8, but many other suitable materials may also be used so long as they are transparent, thin, and electrically insulating. The gaps 10 and insulating material electrically isolate the electrodes 5 from each other. Buss lines 20 that lie atop the insulating layer connect to electrodes 5 through via holes 15 patterned in the insulating layer. This allows each buss line 20 to connect to a corresponding electrode 5 without also connecting to and shorting out the other electrodes 5.

Each of these electro-active lenses 100, 200 also includes a liquid crystal layer and another transparent substrate coated with a ground electrode (not shown) parallel to the plane of the concentric ring electrodes. The liquid crystal layer is sandwiched between the transparent substrates, which may be coated with alignment layers to anchor and/or align the liquid crystal material. Applying voltages to the concentric ring electrodes 5, 20 creates an electric field that extends into the liquid crystal material. This electric field re-aligns the liquid crystal material, changing the refractive index of the electro-active lens along the optic axis direction. Changing the shape and amplitude electric field change the electro-active lens's focusing properties. If the electric field is curved or shaped like a Fresnel lens, for example, then the electro-active lens 100, 200 focuses light. If the electric field is sloped or tilted, then the electro-active lens 100 behaves as a prism.

Unfortunately, the gaps 10 between the concentric ring electrodes 5 introduce gaps, eddies, or discontinuities in the electric field. These gaps, eddies, or discontinuities prevent the electric field from aligning the liquid crystal material in the desired direction, leading to discontinuities in the refractive index profile of the electro-active lens. To a person looking through the electro-active, these discontinuities in the refractive index profile can appear as blurry spots or regions.

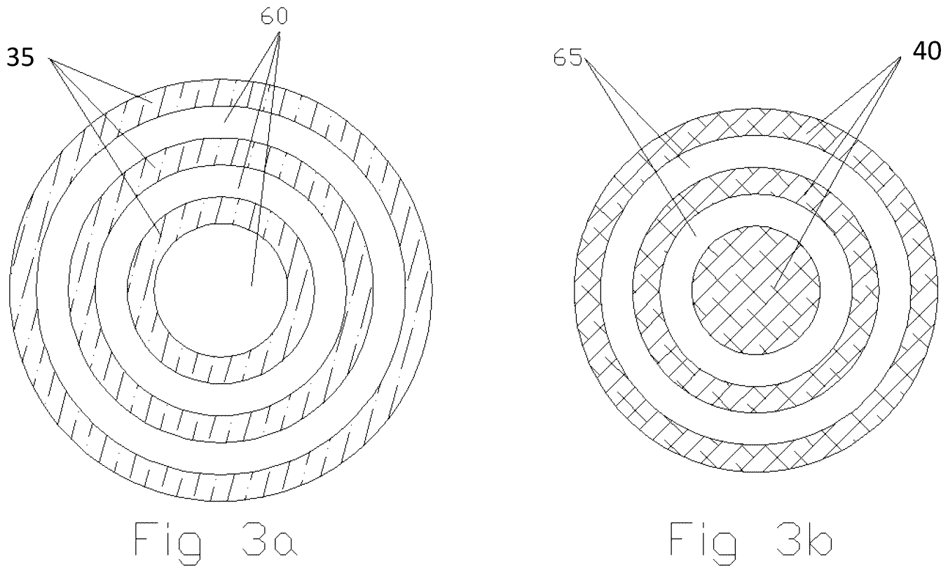

For better optical performance, the gaps 10 between the electrodes 5 should be as narrow as possible. The gaps 10 between lithographically patterned electrodes 5 on a glass substrate can be as narrow as 1.5 to 2.0 microns. At present, however, it is not possible to make gaps that narrow on substrates made of polymers and other materials commonly using to make spectacle lenses, contact lenses, intraocular lenses, and other ophthalmic lenses. For example, FIG. 2 illustrates an electro-active lens 200 with concentric ring electrodes 220 patterned lithographically on a plastic substrate and separated by wider gaps 225. (Buss lines 20 connect to respective electrodes 220 through via holes in an insulating layer that covers the electrodes 220 and gaps 225.) These gaps 225 between the electrodes 220 are about three times as wide (e.g., about 4.5-6.0 μm) as the gaps produced when performing lithography on glass. The larger gaps 225 degrade the optical performance of the electro-active lens 200 with the plastic substrate.

Electro-Active Lenses with Staggered Layers of Electrodes

Reducing or eliminating the apparent gaps between the concentric ring electrodes reduces or eliminates the undesired discontinuities in the electric field applied by the concentric ring electrodes. As a result, the liquid crystal material actuated by the electrodes aligns itself more completely with the electric field. This improves the electro-active lens's optical performance and reduces or eliminates any blurriness perceptible when looking through the electro-active lens.

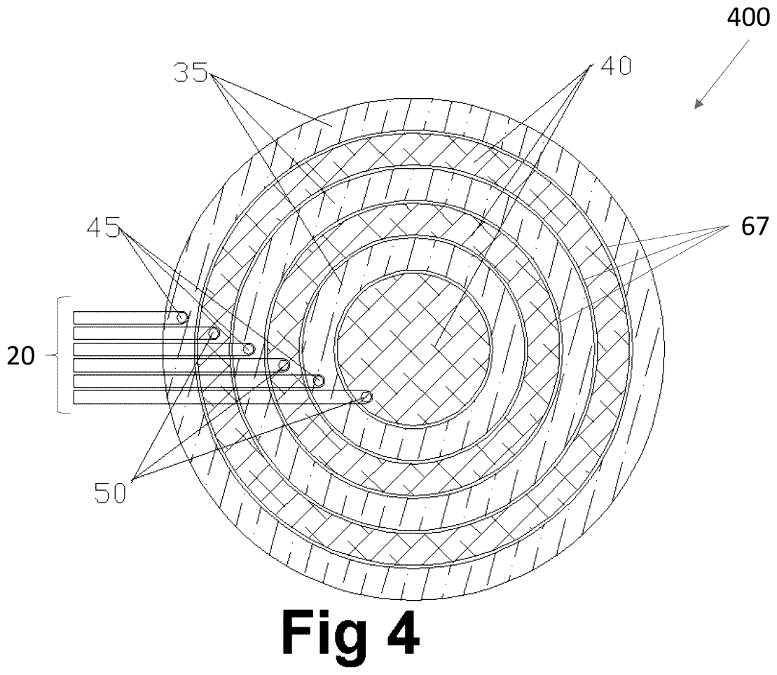

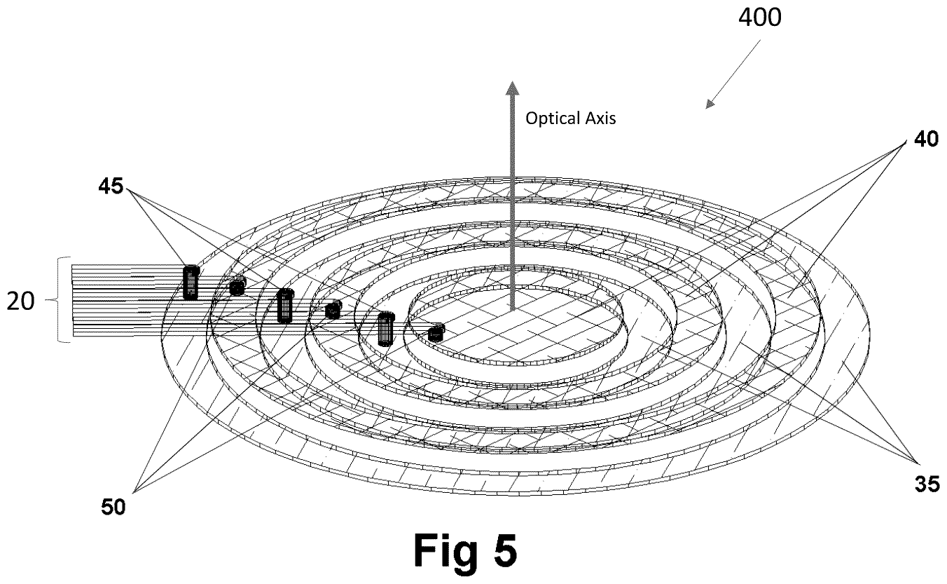

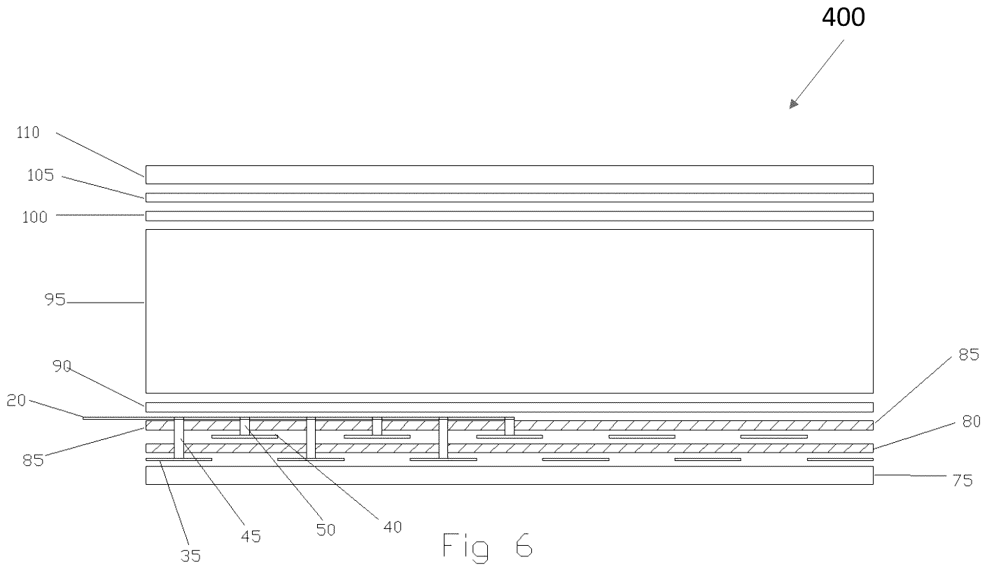

FIGS. 3A, 3B, 4, and 5 show concentric ring electrodes that address the problem of being unable to create electrodes separated by narrow gaps with plastic lithography processes. FIG. 3A shows a single layer of concentric ring electrodes 35 separated by very wide gaps 60 (e.g., gaps that are about 5 microns wide or wider). FIG. 3B shows a second, single layer of concentric ring electrodes 40 (the central electrode is circular rather annular) also separated by very wide gaps 65 (again, e.g., about 5 microns wide or wider). FIGS. 4 and 5 show plan and perspective views, respectively, of these two layers of electrodes 35 and 40 stacked upon each other in a single electro-active lens 400. Both sets of electrodes 35 and 40 are aligned concentric with the optical axis of the electro-active lens 400.

Electrodes 35 are on a lower layer and electrodes 40 are on an upper layer above the lower layer. (The lower and upper layers may be staggered in the opposite sequence if desired.) When viewed along the electro-active lens's optical axis (i.e., the plan view in FIG. 4), each electrode 35 in the lower level appears to be between a corresponding pair of electrodes 40 in the upper level. In other words, the electrodes 35 in the lower level appear to fill the gaps 65 between the electrodes 40 in the upper level, and the electrodes 40 in the upper level appear to fill the gaps 60 between the electrodes 35 in the lower level. If the electrodes 35 and 40 are not as wide as the gaps 60 and 65, then there appear to be very narrow gaps 67 (e.g., gaps about 1.5-2 microns wide or narrower) between apparently adjacent electrodes 35 and 40 as shown in FIG. 4. Even if the electrodes 35 and 40 are on a plastic substrate, the apparent gaps 67 between the electrodes 35 and 40 can be as narrow as the gaps that can be formed on a glass substrate.

Manufacturing tolerances may be considered to ensure that the apparent gaps 67 are as thin as possible (i.e., thinner apparent gaps give better optical performance). Some dimensional tolerance in the lithography used to pattern the electrodes 35 and 40 may cause deviation in the inner diameters, outer diameters, and/or locations of the electrodes. Dimensional misalignment may also occur when forming of the upper layer of electrodes 40 over the lower layer of electrodes 35.

If, for example, a 4-micron overall misalignment can be expected, yet the maximum allowable apparent gap 67 is 2 microns, the diameters of the electrodes 35 and 40 may be altered to compensate. In this example, the lower-level electrodes' outer diameters may be increased by 2 microns, the upper-level electrodes' inner diameters may be decreased by 2 microns, or the inner and/or outer diameters of both set of electrodes diameters may be altered to compensate.

In another embodiment, each electrodes has an outer diameter that is slightly larger than the inner diameter of the next-largest neighboring electrode and an inner diameter that is slightly smaller than the outer diameter of the next-smallest neighboring electrode. In other words, each electrode may overlap with its neighboring electrode, e.g., by 1.5-2.0 μm, to account for misalignment of the electrode layers with respect to each other. A small overlap (e.g., about 2.0 μm or less) should not affect the optical performance of the electro-active lens. A larger overlap between adjacent electrodes may cause the electric fields applied by the adjacent electrodes to interfere or impinge on each other, possibly causing a discontinuity or eddy in the net electric field experienced by the liquid crystal and degrading the optical performance of the electro-active lens.

FIGS. 4 and 5 also show buss lines 20 that connect the electrodes 35 and 40 to a voltage source (not shown) for actuating the electro-active material in the electro-active lens 400. In this example, there is one buss line 20 per electrode 35/40; in other examples, there may be fewer buss lines than electrodes, with resistors (e.g., resistive bridges) connecting sets of adjacent electrodes. The buss lines 20 are deposited on insulating material (not shown) that covers the electrodes 35 and 40 and fills the gaps 60 and 65 between the electrodes 35 and 40. The buss lines 20 connect to the lower electrodes 35 through deeper vias or holes 45 that extend all the way through the insulating material to the lower electrodes 35 and to the upper electrodes 40 through shallower vias or holes 50 that extend partway through the insulating material to the upper electrodes 35.

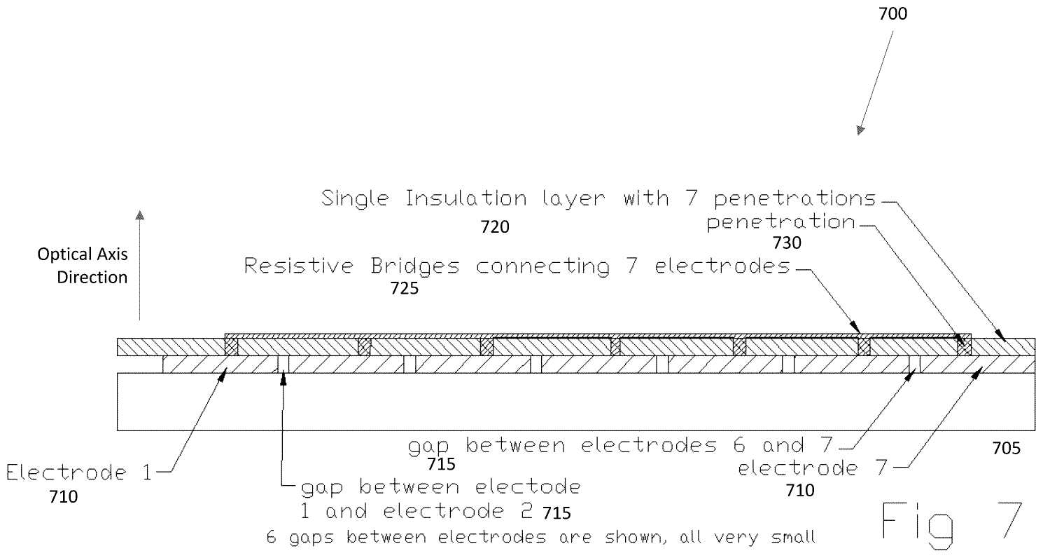

FIG. 6 shows part of the electro-active lens 400 in cross section. The lower electrodes 35 patterned on the upper surface of a clear substrate 75. (Directions are relative to the orientation shown in FIG. 6.) A first insulating layer 80 is applied atop the lower electrodes 35, with the upper electrodes 40 patterned atop the first insulating layer 80. A second insulating layer 85 is applied atop the upper electrodes 40. (FIG. 6 shows only three upper electrodes and three lower electrodes, with labels for only one each.) Many more than three electrodes per level can be used—for example, tens to hundreds or thousands of electrodes—with more electrodes generally producing an electro-active lens with better optical quality.

Two-layer via holes 45 are patterned into the insulating layers 80 and 85 to reach the lower electrodes 35. Buss lines 20 deliver electricity to the lower electrodes 35 through these two-layer via holes 45 but do not connect with the upper electrodes 40. Single-layer via holes 50 are patterned into the second insulating layer 85 and do not extend into or through the first insulating layer 80 or connect to any of the lower electrodes 35. The single-layer via holes 50 deliver electrical power to the upper electrodes 40.

Atop the buss lines 20 and second insulation layer 85 is an alignment layer 90. The alignment layer 90 organizes the liquid crystal molecules in layer 95. Above the liquid crystal layer 95 is a second alignment layer 100. Above alignment layer 100 is an electrically conductive layer 105, which may serve a ground plane for actuating the liquid crystal layer 95 in conjunction with the electrodes 35 and 40. And above the electrically conductive layer 105 is a second clear/transparent substrate 110 (e.g., made of plastic or another transparent polymer). The substrates 75 and 110 sandwich the other layers between them. Although FIG. 6 shows the sides of the electro-active lens 400 are open, in practice they are sealed to prevent leakage of material (e.g., liquid crystal material) into or out of the electro-active lens 400.

Electro-Active Lenses with Raised Resistive Bridges and Single Layers of Electrodes

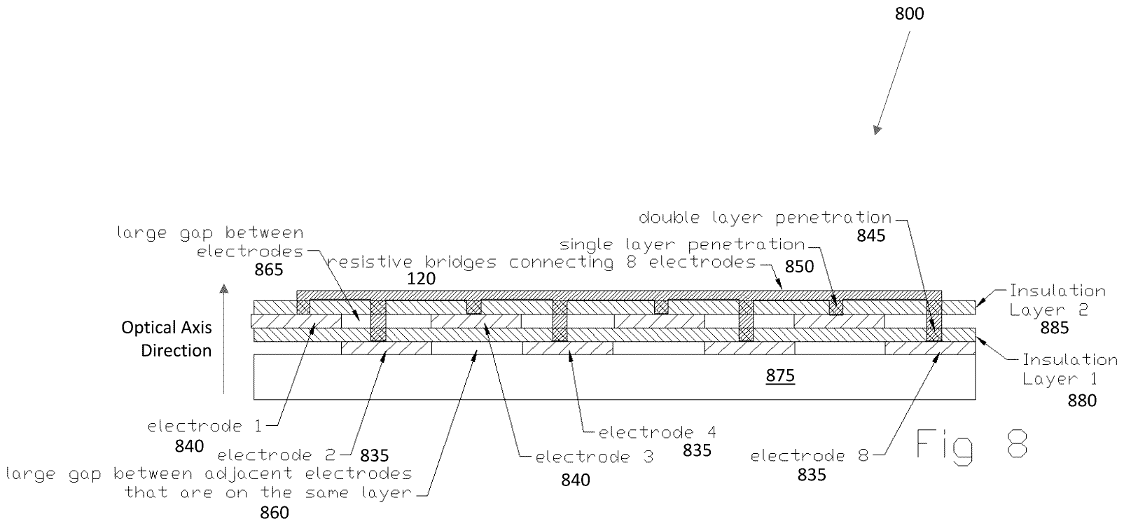

FIG. 7 shows a cross section of part of an electro-active lens 700 with raised resistive bridges 725 that connect selected concentric ring electrodes 710 arranged in a single layer. The electro-active lens 700 includes concentric ring electrodes 710 (e.g., made of ITO or another transparent conductor) formed in a single layer on a transparent substrate 705 (e.g., a glass or plastic substrate). The concentric ring electrodes are co-planar with each other and concentric about the electro-active lens's optical axis, which is perpendicular to the plane of the transparent substrate 705. Because the concentric ring electrodes 710 are in the same layer on the substrate 705, they are separated by gaps 715, which may be about 1.5-5.5 microns wide, depending on the substrate material and the resolution of the (photolithographic) process used to form the electrodes 710. The concentric ring electrodes 710 are coated with a layer 720 of insulating material, which may also be disposed in the gaps 715. Resistive bridges 725 on the insulating layer 720 connect the electrodes 710 through vias or holes 730 in the insulating layer 720.

### Resistive Bridges for Connecting Multiple Layers of Staggered Electrodes

Staggering the electrodes in different layers addresses the inability to create gaps less than 2 microns when lithographically patterning electrodes on plastic substrates. Staggered layers of electrodes can also address another challenge with electro-active lenses: the challenge of creating a smoother wavefront utilizing many electrodes with less than one buss line per electrode phase. If the electro-active lens includes one buss line per electrode phase, then electro-active lens could include a large number of buss lines (e.g., hundreds of buss lines), causing at least two problems. First, buss lines cause visual disturbances in the electro-active lens; as the number of buss lines increases, the optical performance of the lens degrades. Second, as the number of buss lines increases, the complexity of the electronics increases too, and so do the size, weight, power consumption (which reduces battery life), and cost (SWAP-C) of the electronics package. Generally, electro-active spectacle, contact, and intraocular lenses should be light and small as possible, yet have good battery life and economical cost.

For better performance, an electro-active lens should have as many electrodes as possible and as few buss lines as few as possible. One way to reduce the number of buss lines is to use a resistive bridge divider network. However, current resistive bridge designs are limited to a single plane whereas the staggered electrode design described here has electrodes in at least two planes.

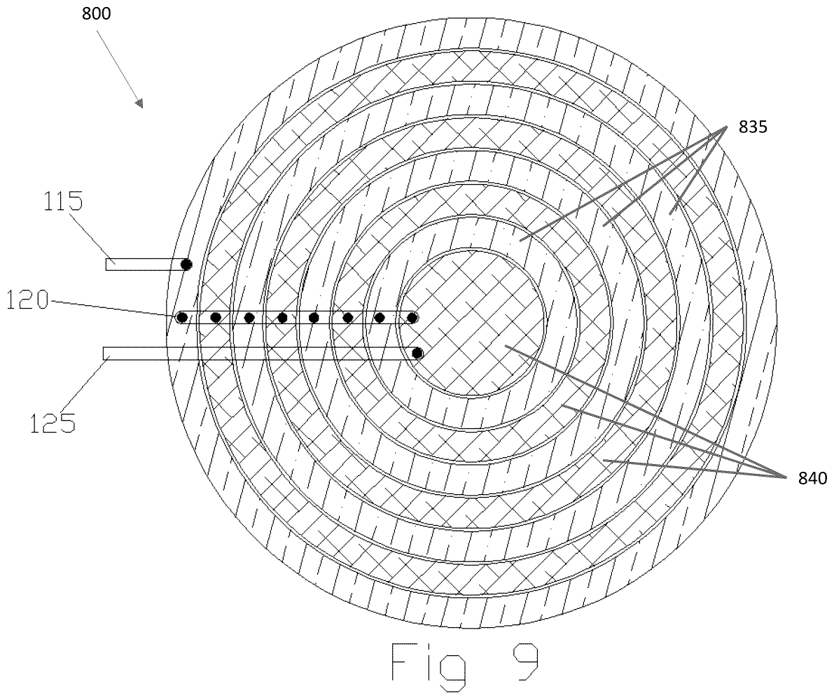

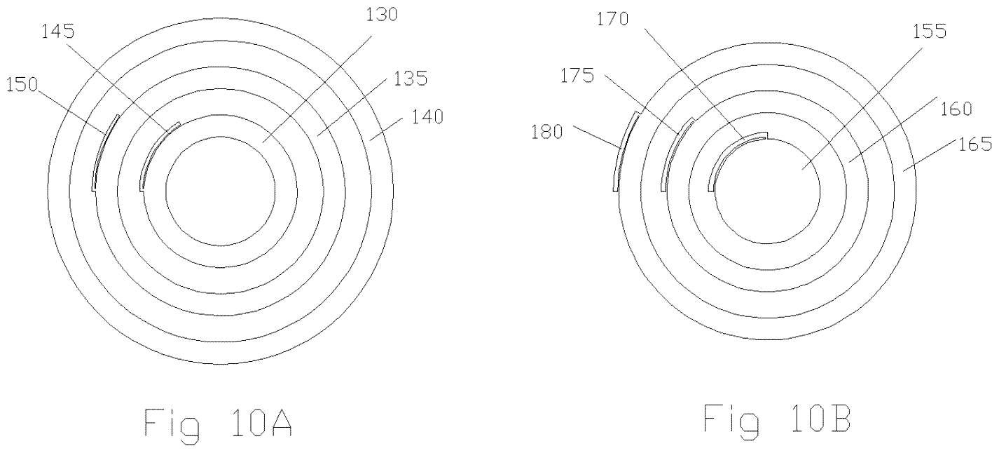

FIGS. 8 and 9 show a cross section and plan view, respectively, of an electro-active lens 800 with multiple layers of staggered electrodes 835, 840 connected by a resistive bridge 120. The electrodes 835, 840 are staggered to reduce or eliminate the apparent gaps between electrodes and any accompanying blurriness. This electro-active lens 800 includes a first layer of concentric ring electrodes 835 on a transparent substrate 875, which can be made of plastic or glass. The concentric ring electrodes 835 are made of patterned conductive material (e.g., ITO) and can be spaced apart by relatively wide gaps, e.g., gaps of 5.5 microns or more, which is possible with photolithography on a plastic transparent substrate. The first layer of concentric ring electrodes 835 is covered with a first layer of insulating material 880, which separates the first layer of concentric ring electrodes 835 from a second layer of concentric ring electrodes 840. This prevents the concentric ring electrodes 835, 840 in the different layers from touching each other and shorting out.

A second layer of insulating material 885 separates the second layer of concentric ring electrodes 840 from a layer of raised resistive bridges 120. The resistive bridges 120 are connected to the concentric ring electrodes 835, 840 in the first and second layers through vias or holes 845, 850 that extend through both insulating layers. In the section of the electro-active lens 800 shown in FIGS. 8 and 9, a single resistive bridge 120 connects all of the concentric ring electrodes 835, 840 to each other, even though the electrodes are in different layers. The innermost electrode 840 and outermost electrode 835 are connected to buss lines 125 and 115, respectively. The resistive bridge 120 can be used to create a voltage gradient between the buss lines 125 and 115 as described in detail in U.S. Pat. No. 10,599,006 to Van Heugten et al., which is incorporated herein by reference.

The concentric ring electrodes 835, 840 in the first and second layers are concentric with the optical axis (and with each other) and interleaved or staggered. If the concentric ring electrodes are numbered consecutively based on their distances from the optical axis, the first layer includes the even-numbered ring electrodes 835 and the second layer includes the odd-numbered ring electrodes 840 (or vice versa). The even-numbered ring electrodes 835 are positioned to “fill” gaps 865 between respective odd-numbered ring electrodes 840, and the odd-numbered ring electrodes 840 are positioned to “fill” gaps 860 between respective even-numbered ring electrodes 835. In this example, the electrodes 835, 840 and gaps 860, 865 have the same widths, but are aligned such that no gap is apparent when looking through the electro-active lens 800 along the electro-active lens's optical axis. The gaps 860, 865 between the concentric ring electrodes 835, 840 in the first and second layers can be filled with the same insulating material used to form the insulating layers 880, 885.

The electro-active lens 800 may include more electrodes and more layers of electrodes (e.g., three layers, with one-third of the electrodes in each layer and staggered accordingly). Likewise, it may include more resistive bridges, with each resistive bridge electrically coupled to a number of neighboring electrodes (e.g., 5-10 electrodes per resistive bridge). And it may include more buss lines (e.g., one buss line per every 5-10 electrodes). More electrodes typically yields better optical performance.

The electro-active lens 800 also includes liquid crystal material trapped between the transparent substrate 875 and another transparent substrate (not shown). Applying a voltage to the concentric ring electrodes 835, 840 actuates the electro-active lens 800 by changing the liquid crystal alignment and the lens's refractive index profile. Because there aren't any apparent radial gaps between the electrodes 835, 840 when the electro-active lens 800 is view along its optical axis, the electric field applied to the liquid crystal material doesn't suffer from the discontinuities that affect electro-active lenses with electrodes in a single layer.

A preferred embodiment of resistive bridges includes first and second layers of resistive arcs on the same planes as the first and second electrodes, respectively, with the arcs on the first plane electrically connected to the electrodes on the second plane, and the arcs on the second plane electrically connected to the electrodes on the first plane. These resistive arcs can be made of the same material that the electrodes are made from, as well as made during the same step as when the electrodes are formed, simplifying the fabrication process. Electrodes in different planes (layers) can be connected by patterning a series of vias through the insulation layers at locations where the resistive bridges should connect electrodes on the different levels, then filling the vias with conductive material when fabricating the buss lines. The electrodes act as etch stops for the vias.

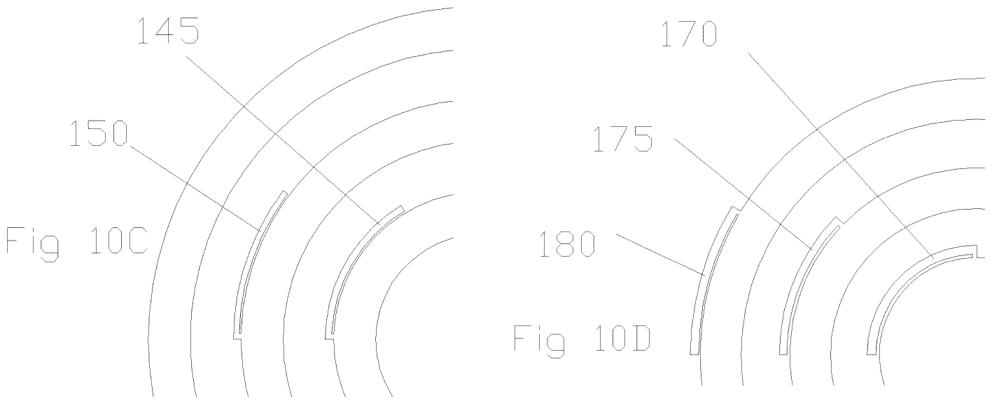

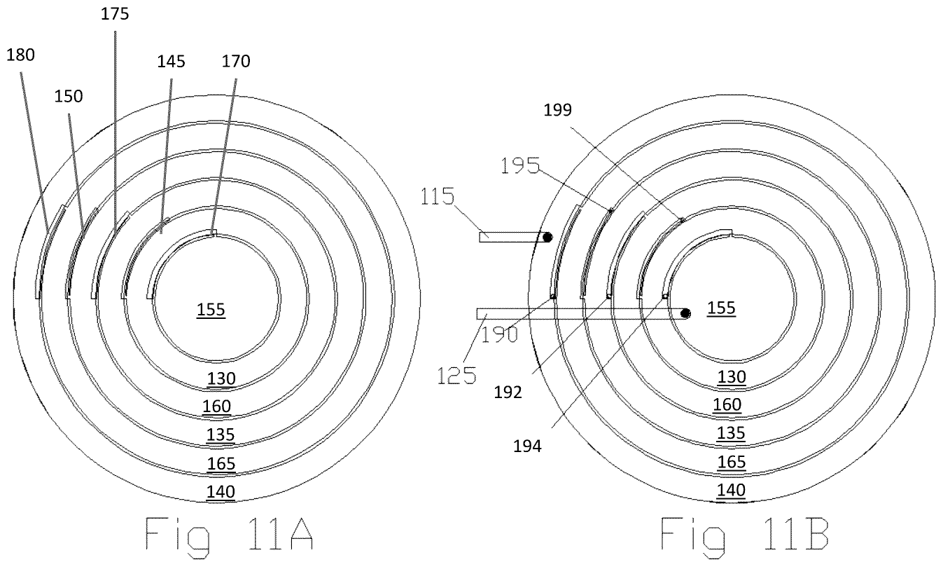

FIGS. 10A-10D, 11A, and 11B illustrate an electro-active lens with two layers of electrodes connected by arcs or resistive bridges. FIGS. 10A and 10B each show a different layer of electrodes and the corresponding arcs. In FIG. 10A, resistive arc 145 is patterned into electrode 130, resistive arc 150 is patterned into electrode 135, and electrode 140 relies upon resistive arc 180 shown in FIG. 10B. In FIG. 10B, resistive arc 170 is patterned into electrode 155, resistive arc 175 is patterned in electrode 160, and resistive arc 180 is patterned into electrode 165. FIGS. 10C and 10D show close-ups of the resistive arcs in FIGS. 10A and 10B, respectively.

FIG. 11A shows a head-on view (i.e., a view along the optical axis) of the electro-active lens with the two layers of electrodes and arcs of FIGS. 10A-10D stacked upon each other. The insulation layer is not shown. FIG. 11B shows the location of the vias, with vias 190, 192, 194, 195, and 199 electrically connecting the lower-level electrodes and resistive arcs to the upper-layer electrodes and resistive arcs. FIG. 11B also shows buss lines 115 and 125 powering the electro-active lens 1000. In this configuration, the two buss lines 115 and 125 power six electrodes without a raised resistive bridge.

Manufacturing Electro-Active Lenses with Staggered Electrode Layers

The electro-active lens 400 shown in FIG. 6 can be made using the following process. To start, the clear substrates 75 and 110 are coated with a clear, electrically conductive material (for example, ITO) typically with a sputtering process or one of several other types of thin film deposition processes known to those skilled in the art. If ITO is used, it can be deposited on each substrate to form a transparent conductive layer with a thickness of 5-100 nanometers.

Photolithography is typically used to pattern the electrodes from the conductive layer on one of the substrates. (The conductive layer on the other substrate can remain unpatterned and serve as a ground plane.) To make the first (lower) layer of electrodes using photolithography process, the surface of the conductive layer to be patterned is coated with photoresist (e.g., with a spin-coating process). The photoresist is masked with a patterned mask, exposed with ultraviolet (UV) light, and then developed. The photoresist exposed to the UV then dissolves away, leaving the unexposed photoresist undissolved and remaining on the substrate. The remaining photoresist covers the sections of the conductive layer that will become the electrodes in the first layer of electrodes. The photoresist does not cover the other sections of the conductive layer. These exposed sections are etched away, e.g., using acid or plasma. After etching, the remaining photoresist is stripped away to leave the patterned electrodes. If the transparent substrate is plastic, then the minimum feature size of the patterned electrodes (e.g., the width of gaps between the electrodes) is typically about 5 microns or more.

Next, the first insulation layer is deposited on the patterned electrodes and in the gaps between the patterned electrodes, e.g., using sputtering or spin coating. A second conductive layer is formed on the first insulation layer and patterned using photolithography to form the second (upper) layer of electrodes. The second insulation layer is deposited on the upper electrodes and in the gaps between the upper electrodes, e.g., using sputtering or spin coating. Then the vias or holes are patterned through the insulation layers using photolithography, with the upper electrodes acting as etch stops for the single-layer vias.

The buss lines can be formed on the same plane as the resistive bridges or a different plane. For example, the buss lines can be formed by depositing a third layer of electrically conductive material on the second insulation layer and in the vias, then photolithographically patterning the electrically conductive material using the process described above with respect to the electrodes. In a preferred embodiment, buss lines are fabricated from low resistance, opaque materials, such as nickel or aluminum, to promote more consistent voltage distribution when differing lengths of buss lines are used. Other high resistance materials can be used if the voltage drops are taken into consideration when the lens and electronics are being designed.

To make raised resistive bridges, another layer of resistive bridge material is deposited, then photolithographically patterned into the desired shapes. The raised resistive bridges can be made from a material with high resistivity so as to reduce electric current flow between buss lines to minimize electrical power consumption. Some example materials are ITO or PDOT. The buss lines can be fabricated before the resistive bridges or vice versa.

Resistive arc bridges can be formed when forming the electrodes. During the via patterning step, additional vias are formed (during the same process step) to electrically connect the arc bridges to the electrodes on the two layers.

Once the electrodes, buss lines, and insulating layers (and possibly the raised resistive bridges) have been formed, an alignment layer is applied to the upper layer of the stack on each substrate, e.g., with a spin coating process. The alignment layers are rubbed in one direction with a felt cloth or exposed to polarized UV light to define a pretilt angle for the liquid crystal material. The two substrates are bonded together, typically spaced apart with transparent spacer beads to form a cavity. Liquid crystal material is introduced into the cavity, typically with vacuum drawing or capillary action. The cavity is sealed to prevent the liquid crystal material, yielding a completed electro-active lens.

The electrodes can vary in width from 2 mm to 5 microns and in thickness from 10 nanometers to 150 nanometers. The insulation layers can be between 20 nm and 1 micron thick. The vias can have diameters between 1 and 20 microns and depths of between 20 nm and 1 micron. The buss lines can be between 1 micron and 20 microns in width and 10 nm to 1 micron in thickness.

Because an electro-active lens with staggered layers of electrodes can tolerate relatively large gaps between the electrodes, the electrodes themselves can be made using fabrication processes, substrates, and/or materials with coarser resolutions. For instance, they can be fabricated on more flexible surfaces using simpler lithography or inkjet printing. Electrodes in different layers can also be made of different materials. They can also be different shapes and can even overlap when view along the optical axis. For example, the rings in the first (second) layer can be wider than the gaps in the second (first) layer.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software, or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the technology disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electro-active lens comprising:
a first plastic substrate;
a second plastic substrate;
liquid crystal material disposed between the first plastic substrate and the second plastic substrate;
first electrodes disposed on the first plastic substrate and separated from each other by first gaps of 5 microns;
an insulating layer disposed on the first electrodes; and
second electrodes disposed on the insulating layer, separated from each other by second gaps of 5 microns, and staggered with respect to the first electrodes.

2. The electro-active lens of claim 1, wherein the first electrodes are first concentric ring electrodes and the second electrodes are second concentric ring electrodes.

3. The electro-active lens of claim 2, wherein, when viewed along an optical axis of the electro-active lens, the first concentric ring electrodes appear to occupy the second gaps and the second concentric ring electrodes appear to occupy the first gaps.

4. The electro-active lens of claim 2, wherein one of the first concentric ring electrodes has a first inner radius and a first outer radius and one of the second concentric ring electrodes has a second inner radius greater than the first inner radius and less than the first outer radius.

5. The electro-active lens of claim 4, wherein the insulating layer is a first insulating layer comprising first insulating material disposed on the first concentric ring electrodes and in the first gaps and electrically isolate the first concentric ring electrodes from each other and from the second concentric ring electrodes.

6. The electro-active lens of claim 5, further comprising:
second insulating material disposed on the second concentric ring electrodes and in the second gaps and electrically isolating the second concentric ring electrodes from each other.

7. The electro-active lens of claim 6, further comprising:
a resistive bridge disposed on the second insulating material and in electrical connection with a subset of the first concentric ring electrodes and a subset of the second concentric ring electrodes.

8. The electro-active lens of claim 6, further comprising:
a first resistive arc formed on the first plastic substrate and connecting one of the first concentric ring electrodes with one of the second concentric ring electrodes through a first via in the first insulating layer; and
a second resistive arc formed on the first insulating layer and connecting another one of the second concentric ring electrodes with another one of the first concentric ring electrodes through a second via in the first insulating layer.

9. An electro-active lens comprising:
a first substantially transparent substrate;
first electrodes disposed on the first substantially transparent substrate;
a first insulating layer disposed on the first electrodes;
second electrodes disposed on the first insulating layer;
a second insulating layer disposed on the second electrodes; and
a resistive bridge connecting one of the first electrodes with one of the second electrodes via a hole patterned in the first insulating layer.

10. The electro-active lens of claim 9, wherein the first electrodes are staggered radially with respect to the second electrodes.

11. The electro-active lens of claim 9, wherein the first electrodes comprise a first ring electrode and the second electrodes comprise a second ring electrode concentric with the first ring electrode.

12. The electro-active lens of claim 11, wherein, when viewed along an optical axis of the electro-active lens, no gap is apparent between the first ring electrode and the second ring electrode concentric.

13. The electro-active lens of claim 11, wherein the first ring electrode has an outer radius at least equal to an inner radius of the second ring electrode.

14. The electro-active lens of claim 9, wherein the resistive bridge is a first resistive arc formed in a plane of the first electrodes, the hole is a first hole, and further comprising:
a second resistive arc formed in a plane of the second electrodes and connecting another one of the first electrodes with another one of the second electrodes via a second hole patterned in the first insulating layer.

15. The electro-active lens of claim 9, further comprising:
gaps between adjacent pairs of the first electrodes and gaps between adjacent pairs of the second electrodes.

16. The electro-active lens of claim 15, wherein at least one of the gaps between the adjacent pairs of the first electrodes is at least 5 microns wide.

17. The electro-active lens of claim 15, further comprising:
insulating material disposed in the gaps between the adjacent pairs of the first electrodes and in the gaps between the adjacent pairs of the second electrodes.

18. The electro-active lens of claim 9, further comprising:
a second substantially transparent substrate; and
liquid crystal material, sandwiched between the first substantially transparent substrate and the second substantially transparent substrate, to change a focus of the electro-active lens in response to actuation by the first electrodes and/or the second electrodes.

19. A method of making an electro-active lens, the method comprising:
forming first electrodes on a substantially transparent substrate with first gaps therebetween;
disposing a first insulating layer on the first electrodes and in the first gaps;
forming second electrodes staggered radially with respect to the first electrodes on the first insulating layer with second gaps therebetween;
disposing a second insulating layer on the second electrodes and in the second gaps; and
forming buss lines connecting to at least some of the first electrodes through the first insulating layer and the second insulating layer and/or to at least some of the second electrodes through the second insulating layer.

20. The method of claim 19, wherein the substantially transparent substrate is a plastic substrate and forming the first electrodes comprises photolithographically patterning the first electrodes with a feature size of at least 5 microns.

21. The method of claim 19, further comprising:
forming a resistive bridge electrically connected to a subset of the first electrodes and a subset of the second electrodes.

22. The method of claim 21, wherein forming the resistive bridge comprises forming a resistive arc in a plane of the first electrodes.
